(19) United States
(12) Patent Application Publication
(10) Pub. No.: US 2026/0223249 A1
(43) Pub. Date: Jul. 30, 2026

(54) END-TO-END LINK MANAGEMENT VIA WTRU-TO-WTRU RELAY

(71) Applicant: InterDigital Patent Holdings, Inc., Wilmington, DE (US)

(72) Inventors: Jung Je Son, Warrington, PA (US); Michelle Perras, Montreal (CA); Taimoor Abbas, Sainte-Julie (CA); Anuj Sethi, Ottawa (CA)

(73) Assignee: InterDigital Patent Holdings, Inc., Wilmington, DE (US)

(21) Appl. No.: 19/143,501

(22) PCT Filed: Dec. 29, 2023
(86) PCT No.: PCT/US2023/086479

§ 371 Date: Jun. 26, 2025

Related U.S. Application Data
(60) Provisional application No. 63/437,222, filed on Jan. 5, 2023.

(51) Int. Cl. H04W 76/30; H04W 76/14; H04W 76/25; H04W 92/18

(52) U.S. Cl. CPC H04W 76/30; H04W 76/14; H04W 76/25; H04W 92/18

(57) ABSTRACT

Systems, methods, and instrumentalities are disclosed herein for end-to-end link management via a wireless transmit/receive unit (WTRU)-to-WTRU relay. A device (e.g., a relay WTRU) may receive, from a first WTRU, a first message, wherein the first message includes a link release request. The device may determine that a second WTRU has an end-to-end connection with the first WTRU via the device. For example, the device may determine the end-to-end connection based on a list of WTRUs having an end-to-end connection with the first WTRU via the device including the second WTRU. The list of WTRUs having an end-to-end connection with the first WTRU may be managed by the device and/or be received from the first WTRU. The device may send an indication that the first WTRU is no longer available via the device to the second WTRU.

### CROSS-REFERENCE TO RELATED APPLICATIONS

This application claims the benefit of Provisional U.S. Patent Application No. 63/437,222, filed Jan. 5, 2023, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to end-to-end link management via a wireless transmit/receive unit (WTRU)-to-WTRU relay. A device may include a processor configured to perform one or more actions. The device may receive, from a first WTRU, a first message, wherein the first message includes a link modification request. The device may send a second message to a second WTRU, wherein the second message includes a first parameter associated with the link modification request. The device may receive, from the second WTRU, a third message, wherein the third message indicates acceptance of the first parameter. The device may send a fourth message to the first WTRU, wherein the fourth message indicates a second parameter associated with the link modification request.

The link modification request includes an end-to-end packet delay budget. The link modification request may be associated with a previously established connection. The previously established connection may be between the first WTRU and the second WTRU via the device. The first parameter may be a packet delay budget for a link between the device and the second WTRU. The second parameter may be a packet delay budget for a link between the device and the first WTRU. The device may determine the first parameter and the second parameter. A sum of the first parameter and the second parameter may satisfy the end-to-end packet delay budget. The device may be a relay WTRU.

A device may receive, from a first WTRU, a first message. The device may determine an availability status of a second WTRU. The device may send, to the first WTRU, an availability message indicating whether the second WTRU is available. The first message may indicate at least one of: that the first WTRU is available for communication with the second WTRU via the device; or a request to confirm availability of the second WTRU via the device. The device may determine that a link between the device and the second WTRU has been released. Based on the determination that the link between the device and the second WTRU has been released, the availability message may indicate that the second WTRU is not available.

The first message may be a keep alive message and the availability message may be a keep alive ack message. The indication that the second WTRU is not available may include an error code included in the keep alive ack message. Determining the availability status of the second WTRU may involve the device sending a second message. The second message may be a keep alive message sent to the second WTRU. The device may receive a third message from the second WTRU. The third message may indicate that the second WTRU is available. Based on the third message, the availability message may indicate that the second WTRU is available.

A device (e.g., a relay WTRU) may communicate with a first wireless transmit/receive unit (WTRU) via a link. The device may receive (e.g., from the first WTRU) an indication to release the link. The indication to release the link may include an end-to-end identifier for communication between the first WTRU and the second WTRU. The device may determine that a second WTRU has an end-to-end connection with the first WTRU via the device. For example, the device may determine the end-to-end connection based on a list of WTRUs having an end-to-end connection with the first WTRU via the device including the second WTRU. The list of WTRUs having an end-to-end connection with the first WTRU via the device may be managed by the device and/or be received from the first WTRU. The device may send an indication to the second WTRU that the first WTRU is no longer available via the device. The indication to the second WTRU may indicate to delete context data associated with the first WTRU from the second WTRU.

The end-to-end connection may comprise IP based communication and/or ethernet based communication. The link may be a PC5 connection.

The device may communicate with a third WTRU via a second link. The device may receive, for example from the third WTRU, a link modification request that may include an end-to-end packet delay budget. The link modification request may be associated with a previously established connection, and the previously established connection may be between the third WTRU and the second WTRU via the device. A third link between the device and the second WTRU may be determined (e.g., by the device) such that the sum of a packet delay budget for the second link and a packet delay budget for the third link satisfy the end-to-end packet delay budget.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a Proximity Services (ProSe) (e.g., 5^{th} Generation (5G) ProSe) discovery integrated into PC5 unicast link establishment.

FIG. 3 illustrates keep alive features with availability information of other WTRUs.

FIG. 4 illustrates end-to-end keep alive features.

FIG. 5 illustrates PC5 unicast keep alive features with end-to-end status indication.

FIG. 6 illustrates a PC5 link release indication.

FIG. 7 illustrates link release features with a WTRU list.

FIG. 8 illustrates end-to-end link modification features.

### DETAILED DESCRIPTION

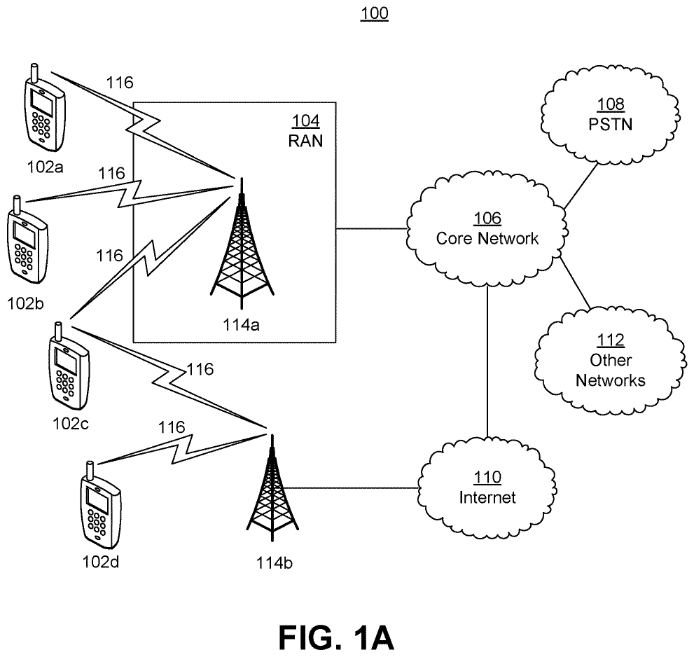

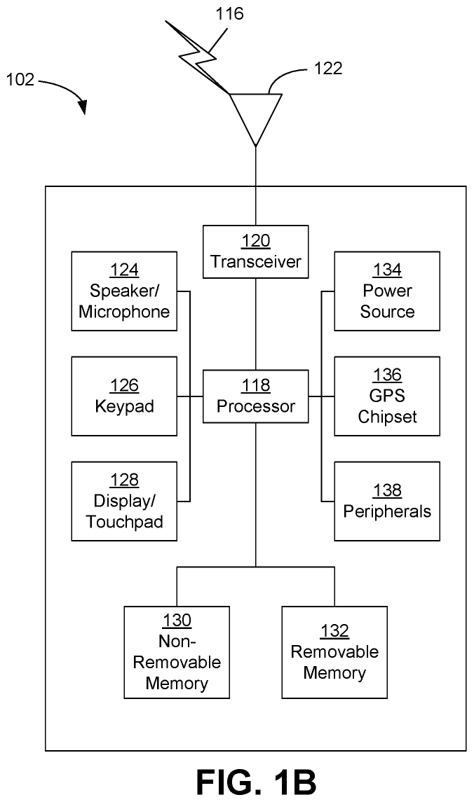

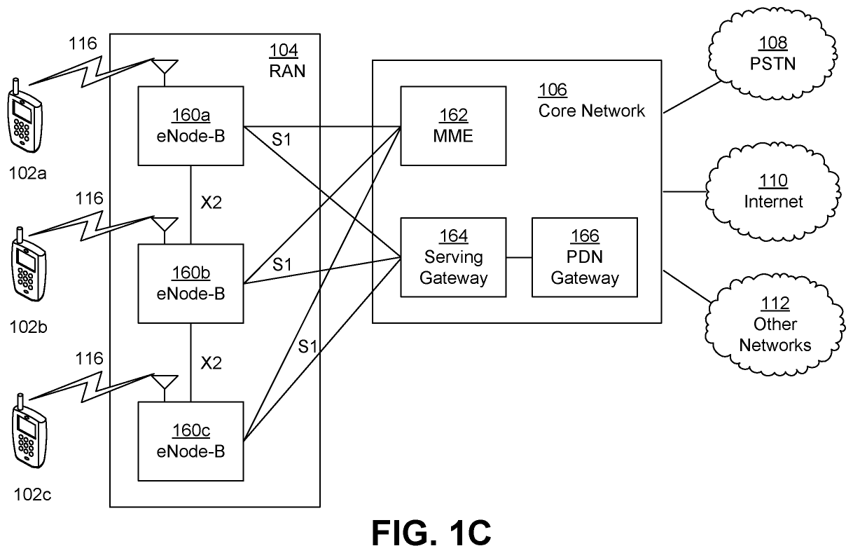

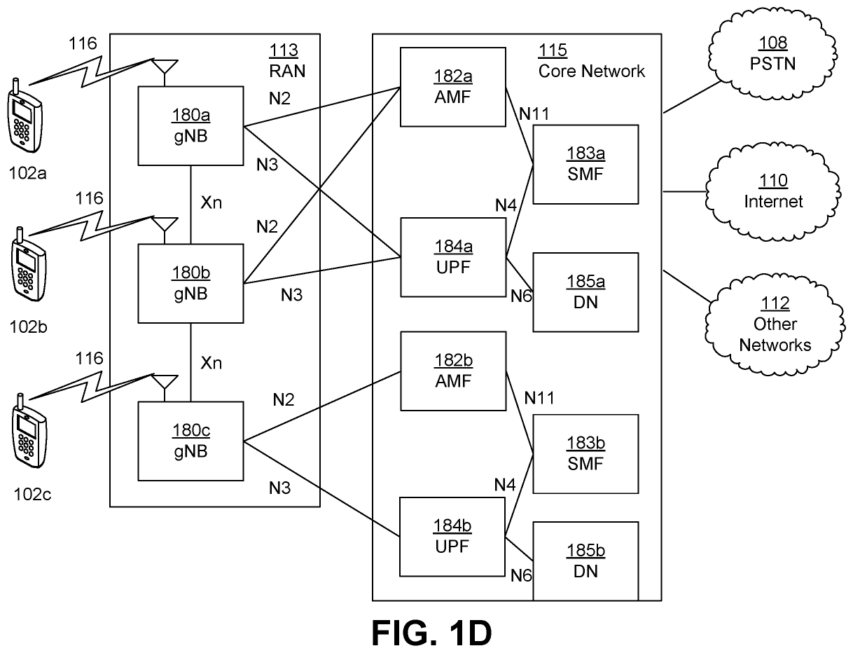

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a timer expiration herein may refer to determining that the time has occurred or that the period of time has expired.

Feature(s) associated with end-to-end (e.g., end WTRU-to-end WTRU) link management (e.g., via a relay) are provided herein. Keepalive features may allow an end WTRU to validate that its peer end WTRU is still reachable over an existing PC5 link (e.g., when the PC5 link is established via a level 3 (L3) WTRU-to-WTRU relay).

Feature(s) associated with 5G Proximity based Services, which may be referred to as Proximity Services (ProSe), are provided herein. ProSe are services that may be provided by the 5^{th} Generation system (5GS) based on WTRUs being in proximity to each other. ProSe (e.g., 5G ProSe) may have functionalities such as 5G ProSe Direct Discovery, 5G ProSe Direct Communication, 5G ProSe WTRU-to-Network relay, 5G ProSe WTRU-to-WTRU relay, and/or the like.

Feature(s) associated with unicast link management are provided herein. In 5G ProSe, link management may be performed (e.g., after establishing a unicast link between two WTRUs). For example, Layer-2 (L2) link release over a PC5 reference point may be performed. WTRUs may release an L2 link by exchanging Disconnect Request and Disconnect Response messages. In releasing L2 link, WTRUs may delete context data (e.g., all context data) associated with the L2 link. The ProSe layer of the WTRUs (e.g., each WTRU) may inform the access stratum (AS) layer that the unicast link has been released. A PC5 Link Identifier may be used to indicate the released unicast link.

L2 link modification for a unicast link may be performed. To add new PC5 Quality of Service (QoS) flow(s), modify existing QoS flow(s), or delete existing QoS flow(s) in the existing PC5 unicast link, WTRUs may exchange Link Modification Request and Link Modification Response messages (e.g., with a requested action, associated QoS information, and/or PC5 QoS rules). The QoS information may include information about PC5 QoS flow(s). The QoS information may include (e.g., for each PC5 QoS Flow) a PC5 QoS Flow Identifier (PFI), corresponding PC5 QoS parameters (e.g., a PC5 5G QoS identifier (PQI) and/or conditionally other parameters (e.g., maximum flow bit rate (MFBR), guaranteed flow bit rate (GFBR), etc.), and/or associated ProSe identifier(s). The ProSe layer (e.g., of each WTRU) may provide information about the unicast link modification to the AS layer. The information about the unicast link modification may enable the AS layer to update the context (e.g., context data) related to the modified unicast link.

L2 link maintenance over a PC5 reference point may be performed. WTRUs may exchange keep alive and keep alive acknowledgement (Ack) messages to detect if a particular PC5 unicast link is still valid. The keep alive features may be initiated based on, for example, triggers from the AS layer or internal timers. The WTRUs may reduce (e.g., minimize) the keep-alive signaling (e.g., by canceling the keep alive features if data is successfully received over the PC5 unicast link). The WTRU (e.g., the WTRU initiating the keep alive features) may determine follow-up actions (e.g., proceed with implicit L2 link release) based on the result of the signaling.

Feature(s) associated with a WTRU-to-WTRU relay are provided herein. 5G ProSe may be associated with features such as, for example, 5G ProSe Direct Discovery, 5G ProSe Direct Communication, a 5G ProSe WTRU-to-Network relay, and a 5G ProSe WTRU-to-WTRU relay.

A 5G ProSe WTRU-to-WTRU relay may enable indirect communication between two WTRUS (e.g., 5G ProSe End WTRUs). For a 5G ProSe WTRU-to-WTRU relay, 5G ProSe WTRU-to-WTRU relay Discovery, and/or 5G ProSe Communication via a WTRU-to-WTRU relay may be performed.

For 5G ProSe WTRU-to-WTRU relay Discovery, Model A and Model B discovery may be (e.g., may both be) supported. Model A may use a (e.g., single) discovery protocol message (e.g., Announcement). Model B may use two discovery protocol messages (e.g., Solicitation and Response). Discovery integrated into PC5 unicast link establishment features may be supported.

5G ProSe communication(s) via a WTRU-to-WTRU relay may be performed via a 5G ProSe L2 WTRU-to-WTRU relay or a 5G ProSe L3 WTRU-to-WTRU relay. For an L2 WTRU-to-WTRU relay and an L3 WTRU-to-WTRU relay, a 5G ProSe communication setup with discovery features may be performed. Discovery integrated into PC5 unicast link establishment features may be performed.

With an L2 WTRU-to-WTRU relay, an end-to-end PC5 link may be established between the end WTRUs, via the relay. PC5-S messages may be exchanged (e.g., then be exchanged) between the end WTRUS.

With an L3 WTRU-to-WTRU relay, the end WTRUs (e.g., each end WTRU) may establish a PC5 link with the relay. The relay may forward messages towards the end WTRUs. PC5-S messages may be exchanged between end WTRUs and the relay.

Feature(s) associated with discovery integrated into PC5 unicast link establishment are provided herein.

Discovery integrated into PC5 unicast link establishment (also sometimes referred to as integrated discovery) may enhance unicast connection setup via a WTRU-to-WTRU relay (e.g., by omitting actions for 5G ProSe WTRU-to-WTRU relay discovery).

For discovery integrated into PC5 link establishment, a WTRU may indicate that the WTRU allows a WTRU-to-WTRU relay to be involved in the Direct Communication Request to another WTRU. For example, the WTRU may include a relay_indication in the broadcasted Direct Communication Request message.

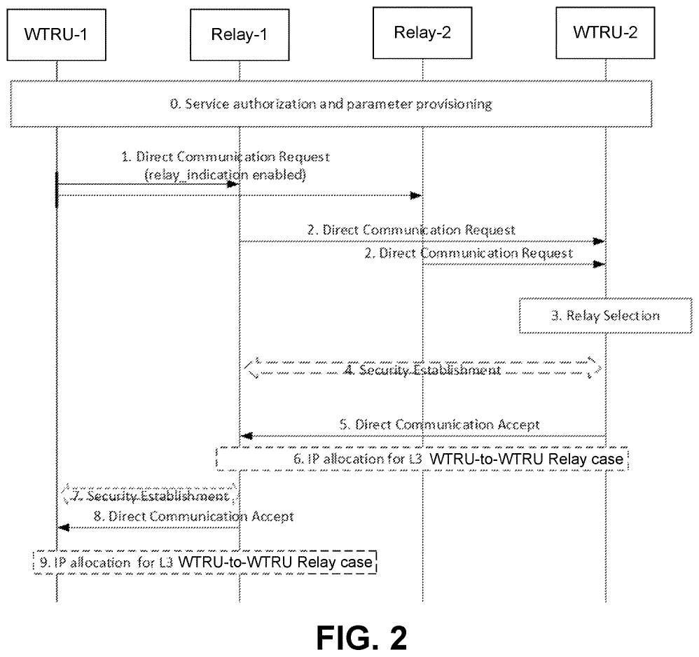

FIG. 2 illustrates an example 5G ProSe Discovery integrated into PC5 unicast link establishment features. If a WTRU-to-WTRU relay receives a Direct Communication Request including a relay_indication, the WTRU-to-WTRU relay may decide to participate and broadcast a Direct Communication Request message in the relay's proximity (e.g., without a relay_indication).

If the target WTRU (e.g., WTRU-2 in FIG. 2) receives a Direct Communication Request from one or multiple WTRU-to-WTRU relay(s), WTRU-2 may select a WTRU-to-WTRU relay to which WTRU-2 will respond. WTRU-2 may reply by sending a Direct Communication Accept message to the selected WTRU-to-WTRU relay (e.g., relay-1 in FIG. 2).

relay-1 may respond with a Direct Communication Accept message to WTRU-1.

Security setup and IP address assignment may be performed (e.g., between relay-1 and WTRU-1, and between relay-1 and WTRU-2).

If one source WTRU communicates with multiple target WTRUs, the PC5 link between the source WTRU and/or the WTRU-to-WTRU relay may be shared for multiple target WTRUs (e.g., per relay service code (RSC). The PC5 links may be established between (e.g., individually established between) the WTRU-to-WTRU relay and target WTRUs (e.g., per RSC). For the shared PC5 link, the L2 link modification may be used. A shared PC5 link may be used for a target WTRU communicating with multiple source WTRUS.

Feature(s) associated with managing the link between two end WTRUs via a WTRU-to-WTRU relay are provided herein.

For 5G ProSe, unicast link management may be used for (e.g., only for) a direct unicast link between WTRUs (e.g., two WTRUs). Link management may not be defined for WTRUs (e.g., two WTRUs) using an indirect link via a WTRU-to-WTRU relay.

Existing link management may not be applied to the link via an L3 WTRU-to-WTRU relay because the current link management messages sent from an end WTRU will be terminated at the WTRU-to-WTRU relay.

Without end-to-end link management, an end WTRU may not be able to determine whether the E2E connection with the other end WTRU is to be released or to be maintained. For example, if a PC5 link between an end WTRU and a WTRU-to-WTRU relay is released because of mobility, the E2E connection of the end WTRU with the other end WTRU via the WTRU-to-WTRU relay may not be available for traffic exchange between the two end WTRUs. Other end WTRUs may be informed of the release of the PC5 link between the end WTRU and the WTRU-to-WTRU relay. If the other end WTRUs are not informed of the release of the PC5 link, the other end WTRUs may waste resource(s) and service quality may be degraded. An E2E link modification may be defined to add or remove a ProSe service or QoS flow(s) for the E2E connection via the WTRU-to-WTRU relay.

Feature(s) associated with WTRUs performing link management for end-to-end connection between WTRUs (e.g., two WTRUs) via a WTRU-to-WTRU relay are provided herein. Keep alive features may be modified to allow an end WTRU to validate that its peer end WTRU is reachable (e.g., still reachable) over an existing PC5 link if the PC5 link is established via a WTRU-to-WTRU relay (e.g., an L3 WTRU-to-WTRU relay). A PC5 signaling message may be used (e.g., together with the keep alive features, or as a standalone feature) to inform an end WTRU that its peer end WTRU is no longer reachable.

Feature(s) associated with end-to-end link management via intervention of a WTRU-to-WTRU relay are provided herein. If a PC5 connection is setup between WTRU-1 and the relay and between WTRU-2 and the relay (e.g., end-to-end between WTRU-1 and WTRU-2 via the relay), WTRU-1, WTRU-2, and the relay may perform keep alive action(s) (e.g., a keep alive procedure). The keep alive action(s) may be for checking availability of a link between WTRU-1 and the relay and availability of a link between WTRU-2 and the relay. The relay may be aware of the connection between WTRU-1 and other WTRUs (e.g., WTRU-2, WTRU-3, etc.). For example, the relay may maintain a list of WTRUs having an end-to-end connection with WTRU-1 via the relay. For example, the relay may receive a list of WTRUs having an end-to-end connection with WTRU-1 via the relay (e.g., from WTRU-1). An end-to-end connection between WTRUs may comprise IP based communication or ethernet based communication.

If WTRU-1 sends a KeepAlive message (e.g., to check the availability of the PC5 connection with the relay), the relay may send a KeepAliveAck message as a response. The relay may send (e.g., include) an indication of whether a PC5 connection with other WTRUs is available (e.g., a list of WTRUs that are available via the relay via a PC5 connection). For example, based on KeepAlive messages and/or other messages exchanged between the relay and WTRU-2 and/or WTRU-3, the relay may determine and send (e.g., include) the availability status of WTRU-2 and/or WTRU-3 (e.g., which have on-going connections with WTRU-1 via the relay). The determination of the availability of the PC5 connection with other WTRUS may be based on the result of communication(s) between the relay and the other WTRUs or a keep alive action(s) between the relay and the other WTRUs (e.g., as described herein). WTRU-1 may (e.g., then) determine (e.g., based on the sent indication), whether a peer WTRU of WTRU-1 is reachable or not reachable via the relay (e.g., whether one or many of its peer WTRUs are reachable or not reachable). For example, the relay may determine that WTRU-2 may be not reachable via the relay following an indication from WTRU-2 to release a link with the relay. The relay may send an indication (e.g., that WTRU-2 is no longer available via the relay) to other WTRU(s) (e.g., WTRU-1) based on the determination that WTRU-2 is no longer reachable.

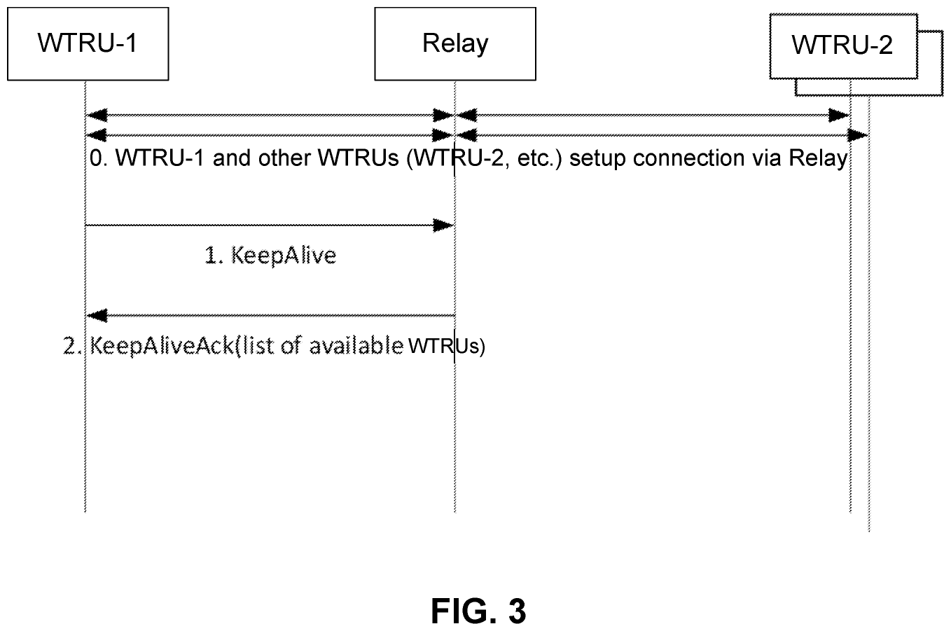

FIG. 3 illustrates example keep alive action(s) (e.g., keep alive procedure) with availability information of other WTRUs (e.g., example keep alive features associated with WTRU-1 and the relay).

The relay may include (e.g., maintain) a list of available WTRUs, e.g., in message(s) sent during the keep alive action(s).

At 0, WTRU-1 and other WTRUs (e.g., WTRU-2, etc., in FIG. 3) may communicate via the relay. The WTRUs (e.g., each WTRU) may have a PC5 connection established with the relay.

At 1, WTRU-1 may send a KeepAlive message to the relay checking the availability of the PC5 connection between WTRU-1 and the relay (e.g., the availability of the PC5 connection between WTRU-1 and the relay to communicate with other WTRUs, for example as described herein). If the relay does not (e.g., within a time period or by a threshold time, etc.) receive a KeepAlive message from a WTRU (e.g., WTRU-1 for example), the relay may determine that the link between the relay and WTRU-1 is unavailable (e.g., WTRU-1 is out of coverage with respect to the relay).

At 2, the relay may respond by sending a KeepAliveAck to confirm the availability of the PC5 connection between WTRU-1 and the relay. The relay may send (e.g., include) a list of available WTRUs. The list of available WTRUs may include WTRUs that have an available PC5 connection with the relay (e.g., based on an ongoing connection and keep alive actions), and in examples are communicating with WTRU-1. The relay may send (e.g., include) a list of unavailable WTRUs. The list of unavailable WTRUs may include WTRUs that recently released their PC5 connection with the relay or that became unavailable for connection with the relay. If the KeepAliveAck is not received by WTRU-1 (e.g., within a threshold amount of time), WTRU-1 may determine that the PC5 connection with the relay is not (e.g., no longer) available.

If WTRU-1 determines (e.g., after WTRU-1 receives the KeepAliveAck message) that an end WTRU, such as WTRU-2, is not available (e.g., anymore), WTRU-1 may try to communicate with the end WTRU via another relay. If WTRU-1 determines that no (e.g., no more) communications with end WTRUs are available via the relay, WTRU-1 may release its PC5 link with the relay.

If WTRUs (e.g., two WTRUs, for example, WTRU-1 and WTRU-2) are communicating via a relay, the WTRUs may perform keep alive action(s) through the relay to check availability of an end-to-end connection between the WTRUs (e.g., via the relay), for example between WTRU-1 (e.g., source) and WTRU-2 (e.g., target). In this case, target WTRU (e.g., WTRU-2) information (e.g., user information, WTRU-2 ID, etc.) may be specified in the keep alive message sent by WTRU-1 to the relay. The target WTRU information may allow the relay to detect that a KeepAlive message should be sent to WTRU-2. A KeepAlive message from the relay to WTRU-2 may include source WTRU (e.g. WTRU-1) information, target WTRU (e.g. WTRU-2) information, and/or relay information.

WTRU-1 and/or WTRU-2 may track a first time (e.g., using a first timer, timer1) for the connection between WTRU-1 and WTRU-2. Timer1 may be started or restarted when a message exchange (e.g., any message exchange) finishes between WTRU-1 and WTRU-2. If no communication occurs before timer1 expires, WTRU-1 and/or WTRU-2 may send KeepAlive message(s) to WTRU-2 and/or WTRU-1, respectively, via the relay to check the availability.

WTRU-1 and/or WTRU-2 may track a second time (e.g., using a second timer, timer2) for the connection between WTRU-1 and WTRU-2. Timer2 may be started or restarted after a message (e.g., any message, including KeepAlive message) is sent. If no response is received, or no traffic exchanges happen in the connection before timer2 expires, WTRU-1 and/or WTRU-2 may determine that the connection between WTRU-1 and WTRU-2 is not available. In this case, WTRU-1 or WTRU-2 may drop the connection with the relay, for example, if the connection with the relay is not being used to communicate with other end WTRUs. WTRU-1 and/or WTRU-2 may try to connect to each other (e.g., establish an end-to-end connection) through other relays.

If the relay does not receive a KeepAliveAck from WTRU-2, or the relay recognizes (or already knows) that the PC5 link between the relay and WTRU-2 is not available, the relay may send to WTRU-1 (e.g., send a response to a KeepAlive message) an indication that WTRU-2 is not available, e.g., a KeepAliveAck with an ErrorCode that indicates that WTRU-2 is not available anymore via the relay.

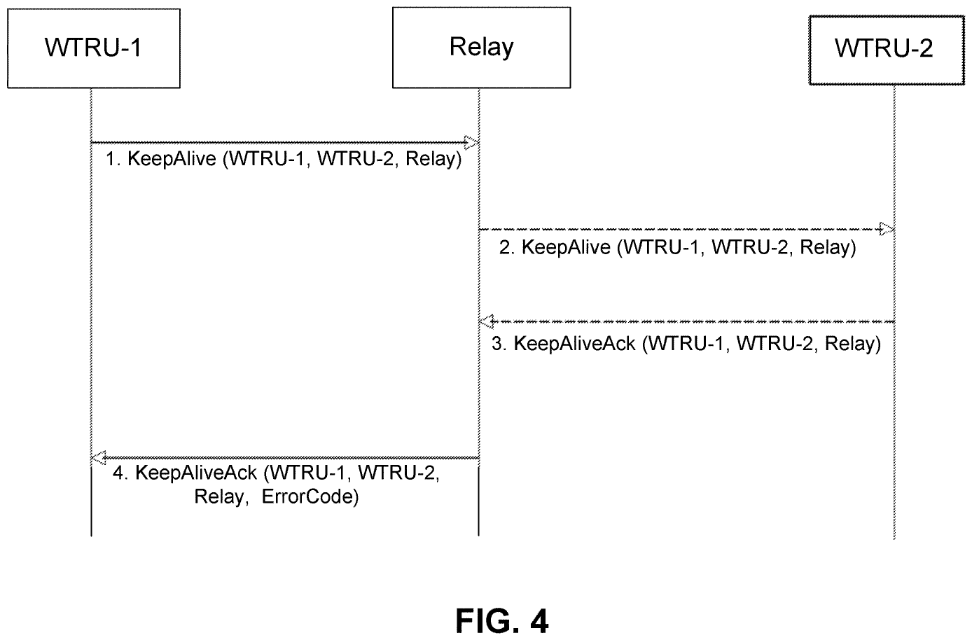

FIG. 4 illustrates example end to end keep alive action(s) (e.g., keep alive procedure).

As illustrated in FIG. 4 at 1, WTRU-1 may send a KeepAlive message to the relay. The KeepAlive message may include an ID and/or user information associated with WTRU-1 and WTRU-2 (e.g., an ID associated with WTRU-1, an ID associated with WTRU-2, user information associated with WTRU-1, and/or user information associated with WTRU-1). The KeepAlive message may include an ID and/or user information associated with the relay.

At 2, the relay may recognize that the KeepAlive message is for end-to-end keep alive (e.g., keep alive between WTRU-1 and WTRU-2 via the relay). The relay may send a KeepAlive message to WTRU-2. The KeepAlive message may include a respective ID and/or respective user information associated with WTRU-1 and WTRU-2 (e.g., an ID associated with WTRU-1, an ID associated with WTRU-2, user information associated with WTRU-1, and/or user information associated with WTRU-1). The KeepAlive message may include an ID or user information associated with the relay.

At 3, if WTRU-2 receives the KeepAlive message, WTRU-2 may respond by sending a KeepAliveAck message. The KeepAliveAck message may include an ID and/or user information associated with WTRU-1 and WTRU-2 (e.g., an ID associated with WTRU-1, an ID associated with WTRU-2, user information associated with WTRU-1, and/or user information associated with WTRU-1). The KeepAliveAck message may include an ID and/or user information associated with the relay.

WTRU-2 may include information (e.g., further information) in the KeepAliveAck message. For example, the KeepAliveAck message may include a future status expectation and/or an indication/request, for example an indication and/or request: that WTRU-2 will be unavailable in the near future (e.g., based on an indicated timer value), to resynchronize an end-to-end connection, to update an end-to-end security association, etc.

At 4, based on the KeepAliveAck message received from WTRU-2, the relay may send a KeepAliveAck message to WTRU-1. The KeepAliveAck message may include an ID and/or user information associated with WTRU-1 and WTRU-2 (e.g., an ID associated with WTRU-1, an ID associated with WTRU-2, user information associated with WTRU-1, and/or user information associated with WTRU-1). The KeepAliveAck message may include an ID and/or user information associated with the relay. If WTRU-2 includes a future status expectation and/or indication/request as described herein, at 4, the relay may include the information in the KeepAliveAck message that is sent to WTRU-1. The KeepAliveAck message may trigger WTRU-1 to perform one or more action(s), for example, security association setup or modification, PC5 connection setup, link modification, and/or the like.

If the relay does not receive a KeepAliveAck message (e.g., within some time) from WTRU-2, e.g., in response to the KeepAlive message at 2, the relay may send to WTRU-1 (e.g., send a response to a KeepAlive message) an indication that WTRU-2 is not available, e.g., a KeepAliveAck message with an ErrorCode that indicates that WTRU-2 is not available via the relay, or that WTRU-2 did not respond to the KeepAlive message from WTRU-1 with a KeepAliveAck message.

After the relay receives the KeepAlive message (e.g., at 1), if the relay is aware (e.g., already aware) that WTRU-2 is not available to communicate with the relay (e.g., anymore), the relay may skip the actions performed at 2 and 3, and respond to WTRU-1 with an indication that WTRU-2 is not available, e.g., a KeepAliveAck message with an ErrorCode which that indicates that WTRU-2 is not available to communicate via the relay.

If WTRU-1 determines that WTRU-2 is not available via the relay, WTRU-1 may try to setup a connection with WTRU-2 via another relay.

After a PC5 link between WTRU-2 and the relay is released, if the relay receives a KeepAlive message from WTRU-1 to check end-to-end link between WTRU-1 and WTRU-2 via the relay, the relay may respond to WTRU-1 with an indication that WTRU-2 is not available (e.g., a KeepAliveAck message with an ErrorCode that indicates that WTRU-2 is not available via the relay).

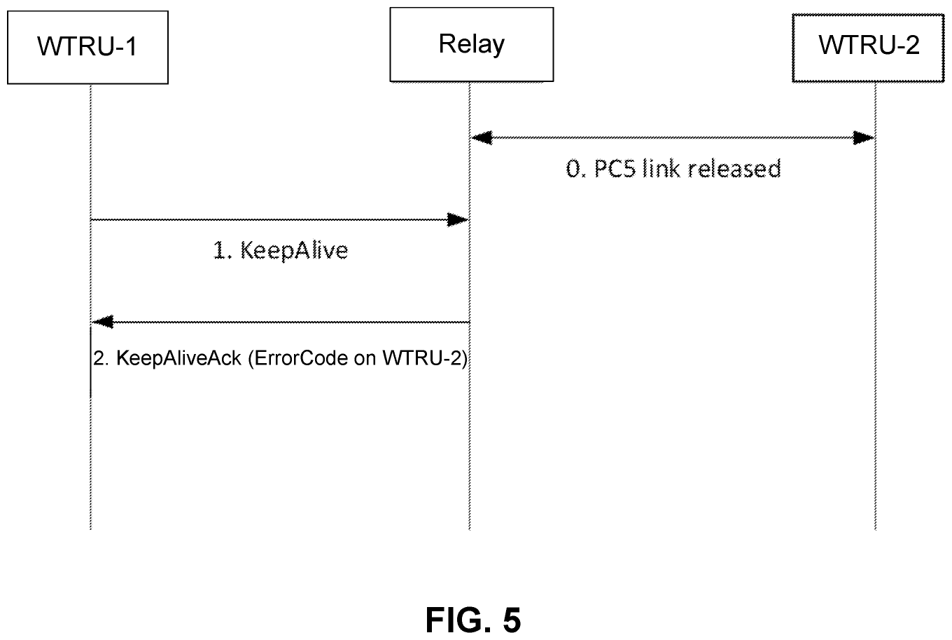

FIG. 5 illustrates example PC5 unicast keep alive action(s) (e.g., procedure) with an end-to-end status indication.

As illustrated in FIG. 5 at 0, the relay and WTRU-2 may release the PC5 connection.

At 1, WTRU-1 may send a KeepAlive message to the relay. The KeepAlive message may include an ID and/or user information associated with WTRU-1 and WTRU-2 (e.g., an ID associated with WTRU-1, an ID associated with WTRU-2, user information associated with WTRU-1, and/or user information associated with WTRU-1). The KeepAlive message may include an ID or user information associated with the relay.

At 2, the relay may be aware that WTRU-2 is not available (e.g., based on the release of the PC5 connection at 1). The relay may respond to WTRU-1 with an indication that WTRU-2 is not available, e.g., a KeepAliveAck message with an ErrorCode thatindicates that WTRU-2 is not available.

If WTRU-1 determines that WTRU-2 is not available (e.g., via messaging from the relay), WTRU-1 may try to setup a connection with WTRU-2 via another relay.

If the PC5 link between WTRU-1 and the relay is released, the relay may inform the other WTRUs (e.g., WTRUs which communicate with WTRU-1 via the relay), including WTRU-2, that WTRU-1 is not available via the relay (e.g., anymore).

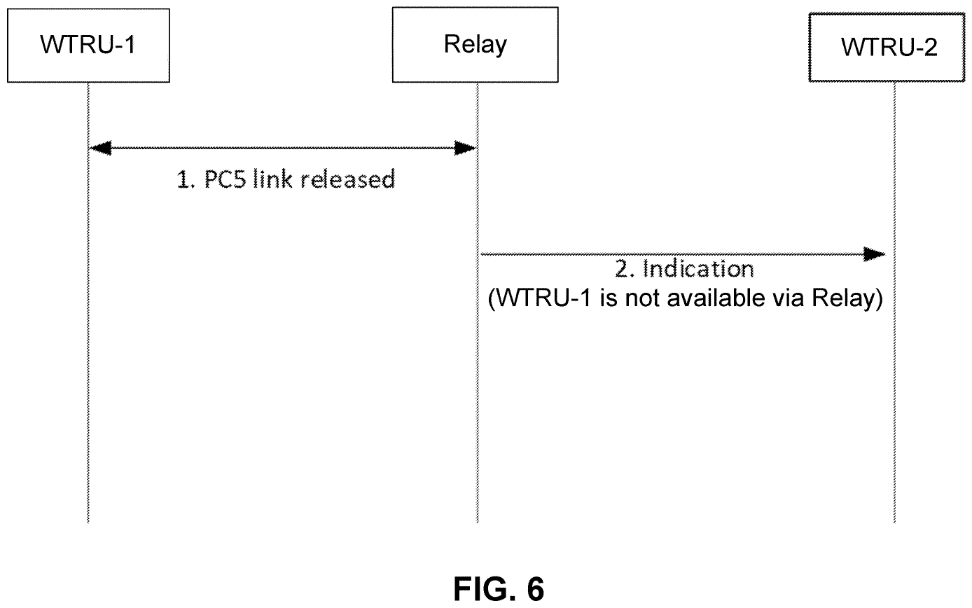

FIG. 6 illustrates an example PC5 link release indication (e.g., a PC5 link release indication procedure).

As illustrated in FIG. 6 at 1, WTRU-1 may release the PC5 link with the relay.

At 2, the relay may send, to WTRU-2, an indication that WTRU-1 is not available via the relay. The relay may send the indication message to the WTRUs (e.g., only to the WTRUs) that have an end-to-end connection via the relay. The relay may determine the WTRUs that have end-to-end connections via the relay based on a managed list of end-to-end connections between WTRUs via the relay. The managed list of end-to-end connections via the relay may be updated whenever two end WTRUs set up a PC5 connection or update an existing PC5 connection via the relay for communication between the two end WTRUs via the relay. The relay may send the indication message in broadcast manner to WTRUs (e.g., every WTRU) that has a PC5 link with the relay.

The relay may update a list of target WTRUs, for example, by removing WTRUs that release the connection with the relay in an announcement message for relay discovery. If WTRUs receive the updated announcement message from the relay (e.g., which does not include WTRU-1 in the list of target WTRUs), the WTRUs may determine WTRU-1 is not available anymore via the relay.

If the relay locally releases the PC5 link with WTRU-1, the relay may send an indication to the WTRUs that are communicating with WTRU-1. For example, the relay may send an indication if WTRU-1 does not respond to KeepAlive messages from the relay, and the number of retransmissions of the KeepAlive messages has reached a maximum number of retransmissions at the relay (e.g., which may be configured in the relay by implementation or signaling from the 5GC during the relay's registration and authorization as relay).

If WTRU-1 releases PC5 link with the relay, WTRU-1 may include a list of target WTRUs that have a connection with WTRU-1 via the relay. The relay may update local list(s) of connected WTRUs that had a connection with WTRU-1 via the relay.

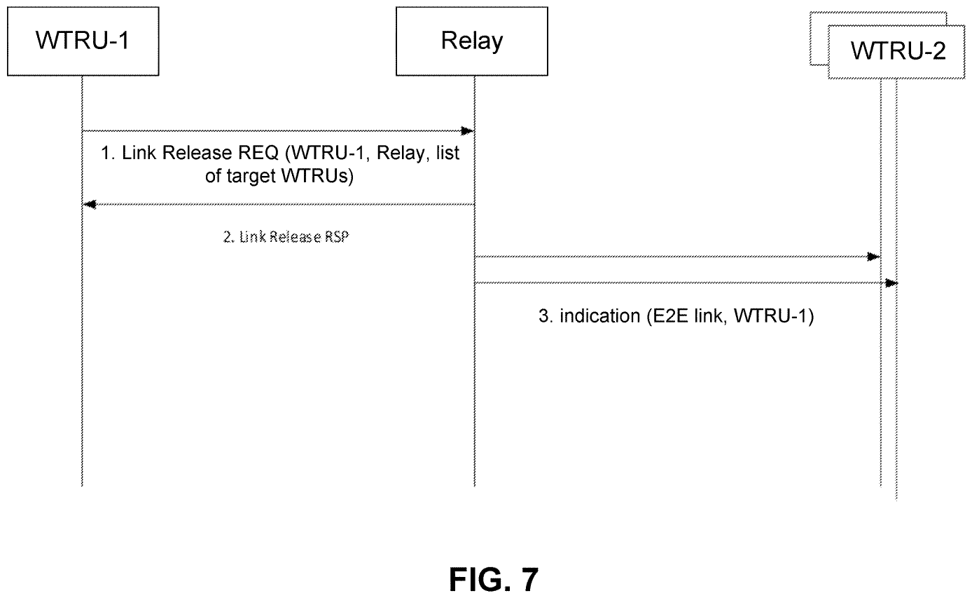

FIG. 7 illustrates example link release action(s) (e.g., procedure) with a WTRU list.

As illustrated in FIG. 7 at 1, WTRU-1 may release the PC5 link with the relay (e.g., by sending a Link Release request). WTRU-1 may include list of target WTRUs (e.g., user information of target WTRUs, IP addresses of target WTRUs, etc.) with which WTRU-1 has connections via the relay.

At 2, if the relay receives the Link Release request from WTRU-1, the relay may respond with a Link Release response, and may delete information relating to WTRU-1.

At 3, the relay may send (e.g., either during or after the actions described at 2 are performed) an indication that an end-to-end link with WTRU-1 is not available to WTRUs (e.g., each WTRU) in the list of target WTRUs (e.g., the list of target WTRUs sent at 1).

The indication that the end-to-end link with WTRU-1 is not available may be embedded in other signaling messages such as a link release request, response messages, and/or a KeepAlive message between the target WTRUs and the relay.

After receiving indication at 3, WTRUs may try to setup a connection with WTRU-1 via another relay.

After establishing connections via the relay, WTRU-1 and WTRU-2 may update the link for adding or removing some ProSe services and/or QoS flows relating to some ProSe services. If WTRU-1 and WTRU-2 update the link (e.g., via the relay), WTRU-1 and WTRU-2 may exchange a link modification request and a link modification response (e.g., which may include an ID and/or user information associated with WTRU-1 and WTRU-2, for example, an ID associated with WTRU-1, an ID associated with WTRU-2, user information associated with WTRU-1, and/or user information associated with WTRU-1, and/or requested ProSe services for modification and the related QoS parameters of the ProSe services).

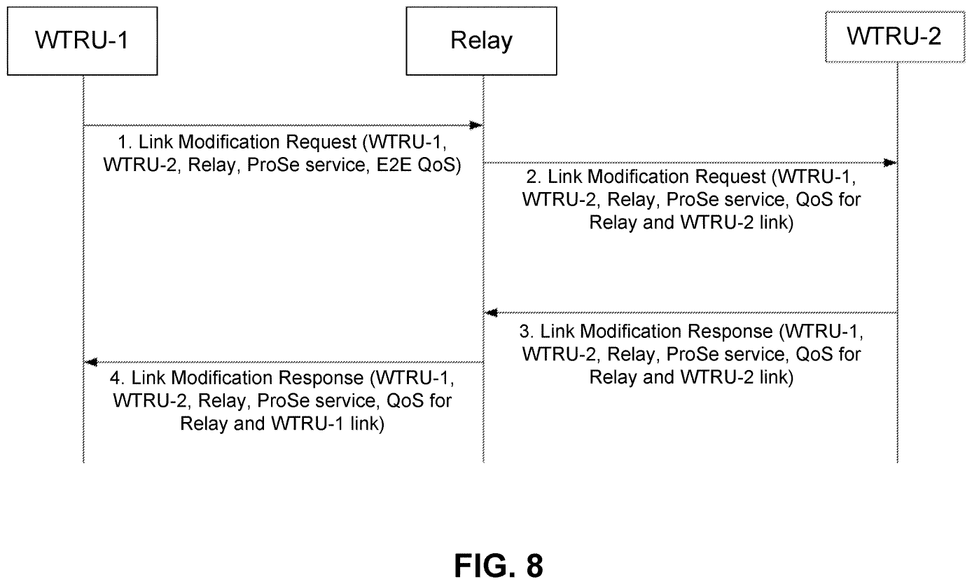

FIG. 8 illustrates example end-to-end link modification action(s) (e.g., procedure).

As illustrated in FIG. 8 at 1, WTRU-1 may send to the relay a link modification request to update ProSe services for the connection with WTRU-2 via the relay. The link modification request may include an ID and/or user information associated with WTRU-1 and WTRU-2 (e.g., an ID associated with WTRU-1, an ID associated with WTRU-2, user information associated with WTRU-1, and/or user information associated with WTRU-1) and/or requested ProSe service and requested QoS information between WTRU-1 and WTRU-2 via the relay (e.g., end-to-end (E2E) QoS information, such as a packet delay budget). The link modification request may include an ID and/or user information associated with the relay.

QoS information may include information about PC5 QOS flow(s). QoS information may include (e.g., for each PC5 QoS flow) information about the PFI, the corresponding PC5 QOS parameters (e.g., PQI and (conditionally) other parameters such as MFBR/GFBR, etc.), and (optionally) the associated ProSe identifier(s).

At 2, if the relay receives a link modification request for updating ProSe services and QoS flows for the connection between WTRU-1 and WTRU-2 via the relay, the relay may send a link modification request to the WTRU-2. The link modification request from the relay may include the requested ProSe services (e.g., as received at 1) and related QoS information for the link between the relay and WTRU-2 (e.g., which may be derived based on the end-to-end QoS information received at 1). For example, a packet delay budget for the link between the relay and WTRU-2 may be determined by the relay so that sum of the delay between WTRU-1 and the relay and the delay between WTRU-2 and the relay does not exceed the end-to-end delay budget between WTRU-1 and WTRU-2 via the relay.

At 3, if WTRU-2 receives a link modification request from the relay (e.g., which may include the ID and/or user information of WTRU-1 and WTRU-2 (e.g., an ID associated with WTRU-1, an ID associated with WTRU-2, user information associated with WTRU-1, and/or user information associated with WTRU-1) and the requested ProSe services and relating QoS information), WTRU-2 may respond by sending a link modification response to the relay. The link modification response may include the ID and/or user information of WTRU-1 and WTRU-2 (e.g., an ID associated with WTRU-1, an ID associated with WTRU-2, user information associated with WTRU-1, and/or user information associated with WTRU-1) and the requested ProSe services and related QoS flows (e.g., which may indicate implicitly that the link modification request is accepted by the responding end WTRU, or, an explicit acceptance may be indicated).

At 4, the relay may respond to WTRU-1 with link modification response (e.g., after receiving the link modification response from WTRU-2). The link modification response may include an ID and/or user information associated with WTRU-1 and WTRU-2 (e.g., an ID associated with WTRU-1, an ID associated with WTRU-2, user information associated with WTRU-1, and/or user information associated with WTRU-1) and requested ProSe services and related QoS information of the ProSe services for the link between WTRU-1 and the relay.

An end-to-end link identifier (e.g., for connection between WTRU-1 and WTRU-2 via the relay) may be determined between WTRU-1 and WTRU-2, or may be determined by the relay. The end-to-end link identifier may be included in the link modification request and link modification response. The end-to-end link identifier may be used to determine that the link modification request and/or response is for modifying the link between WTRU-1 and WTRU-2 and the relay. In this case, based on the end-to-end link identifier information, user information associated with WTRU-1 and WTRU-2 may be derived and may be used to check whether the request and response message are valid and/or from a legitimate entity.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-15. (canceled)

16. A device comprising:
a processor configured to:
communicate with a first wireless transmit/receive unit (WTRU) via a link;
receive, from the first WTRU, first information, wherein the first information comprises an indication to release the link;
determine, based on the first information, that the link is no longer available;
determine that a second WTRU has an end-to-end connection with the first WTRU via the device based on a list of WTRUs associated with the device, wherein the list of WTRUs includes the second WTRU; and
send second information to the second WTRU, wherein the second information indicates that the first WTRU is no longer available via the device.

17. The device of claim 16, wherein the processor is further configured to, based on the determination that the link is no longer available, update the list by removing the first WTRU from the list.

18. The device of claim 17, wherein the processor is further configured to send an announcement message that indicates or includes the updated list.

19. The device of claim 18, wherein the second information comprises the updated list or the second information comprises the announcement message.

20. The device of claim 16, wherein the end-to-end connection is at least one of an IP based communication or an ethernet based communication.

21. The device of claim 16, wherein the link is a PC5 connection.

22. The device of claim 16, wherein the second information further indicates to delete context data associated with the first WTRU from the second WTRU.

23. The device of claim 16, where in the processor is further configured to:
communicate with a third WTRU via a second link; and
receive, from the third WTRU, third information, wherein the third information indicates a link modification request that includes an end-to-end packet delay budget.

24. The device of claim 23, wherein the link modification request is associated with a previously established connection, and wherein the previously established connection is between the third WTRU and the second WTRU via the device.

25. A method comprising:
communicating with a first wireless transmit/receive unit (WTRU) via a link;
receiving, from the first WTRU, first information, wherein the first information comprises an indication to release the link;
determining, based on the first information, that the link is no longer available;
determining that a second WTRU has an end-to-end connection with the first WTRU via a device based on a list of WTRUs associated with the device, wherein the list of WTRUs includes the second WTRU; and
sending second information to the second WTRU, wherein the second information indicates that the first WTRU is no longer available via the device.

26. The method of claim 25, wherein the method further comprises, based on the determination that the link is no longer available, updating the list by removing the first WTRU from the list.

27. The method of claim 26, wherein the method further comprises sending an announcement message that indicates or includes the updated list.

28. The method of claim 27, wherein the second information comprises the updated list or the second information comprises the announcement message.

29. The method of claim 25, wherein the end-to-end connection is at least one of an IP based communication or an ethernet based communication.

30. The method of claim 25, wherein the link is a PC5 connection.
